(19) United States
(12) Patent Application Publication
(10) Pub. No.: US 2014/0359034 A1
(43) Pub. Date: Dec. 4, 2014

(54) Methods and Systems for Automatically Making Acts of Advocacy Based on Content in Electronic Information Streams

(71) Applicants: David A. Hernandez, Chicago, IL (US); Mark Skroch, Chicago, IL (US); Christopher O'Brien, Evanston, IL (US); Joseph Rosenthal, Glencoe, IL (US); Michael Blocher, Chicago, IL (US)

(72) Inventors: David A. Hernandez, Chicago, IL (US); Mark Skroch, Chicago, IL (US); Christopher O'Brien, Evanston, IL (US); Joseph Rosenthal, Glencoe, IL (US); Michael Blocher, Chicago, IL (US)

(21) Appl. No.: 14/288,524

(22) Filed: May 28, 2014

Related U.S. Application Data
(60) Provisional application No. 61/829,322, filed on May 31, 2013.

(51) Int. Cl. H04L 12/58; G06F 17/30

(52) U.S. Cl. CPC H04L 51/02; G06F 17/30516
USPC 709/206

(57) ABSTRACT

This patent discloses inventive methods and systems for automatically monitoring an electronic information stream for the occurrence of preconfigured trigger condition, such as the presence of keywords, images, and other identifiable stream content. Upon recognition of the preconfigured trigger condition, the inventive methods and systems automatically make a donation, send a counter-statement, or take some other preconfigured advocacy action related to the stream and trigger condition.

### RELATED APPLICATIONS

This application claims the benefit of U.S. Provisional Application Ser. No. 61/829,322, filed May 31, 2013, and incorporates it by reference in its entirety for all purposes.

### BACKGROUND OF THE INVENTION

Consumers of information have always received, in various formats, news reports and opinions relating to current events. In the past, most of this information came in the form of person-to-person interactions or through printed media. And in response to receipt of news reports and opinions, consumers of information may have chosen to engage in some form of advocacy, for example, by writing a letter to the editor, by forming or joining a group of other consumers, or by making a financial contribution in support of or in opposition to the news report or opinion.

In today's electronic age, “person-to-person” transmission of information may take the form of a network news show where the news anchor presents the events of the day, and “printed” media may take the form of the daily news presented on the newspaper's online web page. However, a consumer of information may also receive news reports and opinions, not just at a preschedule time of day, but soon as then have been written. Moreover, these electronically-delivered streams of information can come from virtually any source, not just from the traditional news outlets.

And as was the case with non-electronically-delivered information, the consumer of information may choose to respond with some form of advocacy. However, a number of factors may hamstring the recipient's efforts:

First, the sheer volume of information can overwhelm even the most devoted consumer. Not only are there thousands of online newspapers delivering news reports and opinions, there are hundreds of millions of “tweets” posted to Twitter each day, hundreds of millions of publicly-accessible bogs, over a billion active Facebook users posting regularly, and scores of other streams of electronic information using not only the written word but also photographs, video, and audio.

Second, whereas a traditional newspaper might have a printed edition delivered every morning, and television network news might have an evening edition and a weekly summary on Sunday mornings, electronically-delivered streams of information know no such cycle. Indeed, as demonstrated by recent events, social media sources such as Twitter provide streams of information in near real time as the events unfold. By the time a consumer of information would have received the same news reports from a regularly scheduled news source, the news may be hours or days old.

Third, history shows that a consumer of information who is inclined to respond to a current event is most likely to act immediately after learning the event. For example, a day after a tornado devastates a town, donations of money and supplies may pour into charitable and relief organizations. But a month later, even though the need is just a great, those charitable and relief organizations may be struggling to find sufficient donors to meet the needs of the devastated town.

Fourth, with the deluge of information available via the Internet, savvy consumers of information recognize that not every source is reputable. Some news and opinions come from those who simply lack sufficient facts to reach the conclusions reflected in their tweets or bogs, while other news and opinions come from those having an agenda to distort the facts for political or monetary gain. Prior to making some act of advocacy—for example, donation money or posting a counter-position—a consumer of information may want to investigate the legitimacy of the source of the news report. However, by the time the consumer is satisfied as to the veracity of the report, the news may have become stale and the consumer may have lost the sense of urgency to make a response.

Fifth, different consumers of information will be motivated to respond to different events with different forms of advocacy. For example, a consumer with an interest in gun control may want to monitor specific blogs, Twitter feeds, and Facebook pages related to the National Rifle Association. In response to specific content, for example, the use of the phrase “assault rifle,” one consumer may choose to make a donation to the NRA, another may choose to make a donation to the Brady Campaign to Prevent Gun Violence, and another may simply want to share a link to the information on Facebook.

There are known solutions for certain aspects of these problems. For example, sophisticated traders may electronically monitor stock market tickers and then buy or sell based on predefined prices, email filters may electronically scan incoming mail and automatically handle the messages according to predefined keywords or sender names, and social media platforms may present specific advertisements based on user behavior.

However, what has heretofore been lacking is an integrated system that would monitor a predefined stream of electronic information for occurrences of predefined trigger, and in response, would make a predefined act of advocacy in support of or opposition to the trigger.

### SUMMARY OF THE INVENTION

The present invention addresses the foregoing problems by providing an inventive computer-based platform that allows a consumer of information to preconfigure (a) a public electronic information stream to be monitored, (b) a keyword, phrase, or other recognizable trigger condition, and (c) an advocacy response to be taken automatically upon occurrence of the trigger in the information stream. Once configured, the inventive platform electronically monitors the designated electronic information stream. When the inventive platform recognizes an occurrence of the predefined trigger in the stream, it will automatically make the advocacy response that was preconfigured by the consumer.

By way of example and not limitation, the electronic information stream could be an automated feed such as Twitter or RSS, it could come from automatically periodically polling a web site for new postings to a Facebook page, blog, or bulletin board such as Reddit, or it could be a live news feed coming from a traditional or Internet news broadcast. The electronic information stream could be in the form of a simple text message, but it could also be the close-captioning text accompanying the audio or video portion of a broadcast. Further, the inventive platform could include voice-recognition software that converts voice found in audio or video feeds into a text stream. Further, the inventive platform could include pattern-recognition software that looks for specific objects or faces in a motion video and/or still photograph stream, or specific songs or artists in an audio or video stream.

By way of example and not limitation, the inventive platform could be counting the number of occurrences of a trigger in a single message, the number of occurrences of the trigger coming from a specific source, the number of postings by a specific source, or any combination of these. Further, the inventive platform could take action based on every occurrence of the trigger or it could take action after the count reached some threshold value. Further, the inventive platform could be aggregating occurrences, for example by making a fixed donation for every 100 likes of some organization's Facebook page.

By way of example and not limitation, in response to the occurrence of a trigger in a monitored electronic information stream, the inventive platform could generate an electronic payment from a consumer to a charity of the consumer's choosing, using an electronic check, credit card, PayPal, or any other electronic payment mechanism. Alternatively, or in addition, the inventive platform could incorporate a reference to the occurrence of the trigger into a predefined message suitable for tweeting or posting to a social media platform.

In addition to these components, the inventive platform would also include a suitable user interface that allows the consumer of information to create accounts, configure electronic information streams to be monitored, configure triggers, and configure actions to be taken upon occurrences of the triggers in the electronic information streams. Further, the inventive platform would also include suitable electronic interfaces for communicating with electronic information streams as well as with electronic payments systems. These user and electronic interfaces would be built using application programming interfaces and other software tools known to those of ordinary skill in the art.

### BRIEF DESCRIPTION OF THE DRAWINGS

FIG. 1 is a block diagram of an embodiment of the present invention.

FIG. 2 is flow chart depicting the processing logic of an embodiment of the present invention.

FIG. 3 is a high-level web site map showing the interaction of various pages on a website developed to implement an embodiment of the present invention.

FIG. 4 is an example of a new user home page in an embodiment of the present invention.

FIG. 5 is an example of a logged-in user's home page in an embodiment of the present invention.

FIG. 6 is an example of a settings page in an embodiment of the present invention.

FIG. 7 is an example of a pledge page in an embodiment of the present invention.

FIG. 8 is an example of a payment setup page in an embodiment of the present invention.

FIG. 9 is an example of a counter-tweet setup page in an embodiment of the present invention.

### DETAILED DESCRIPTION OF THE INVENTION

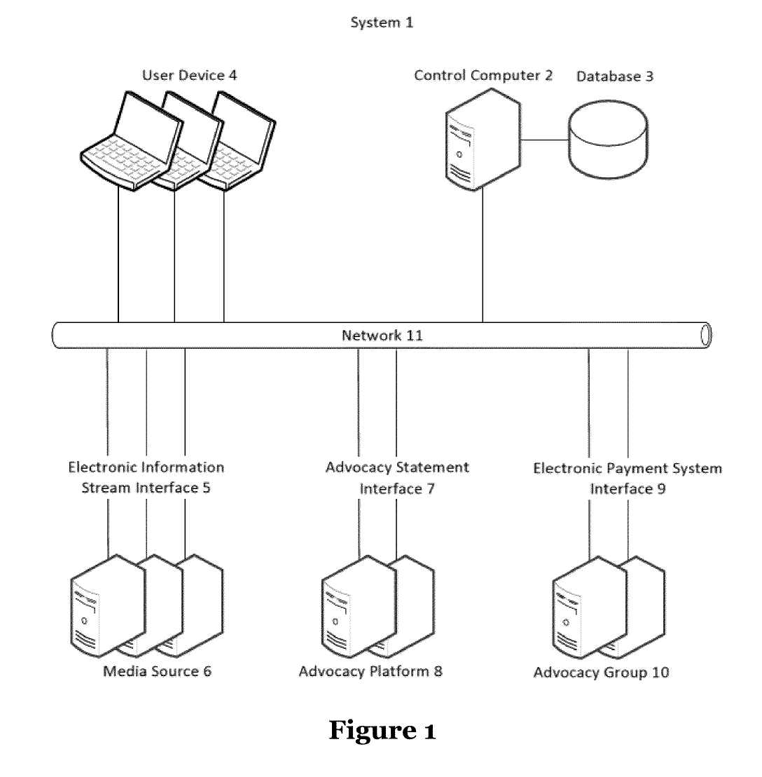

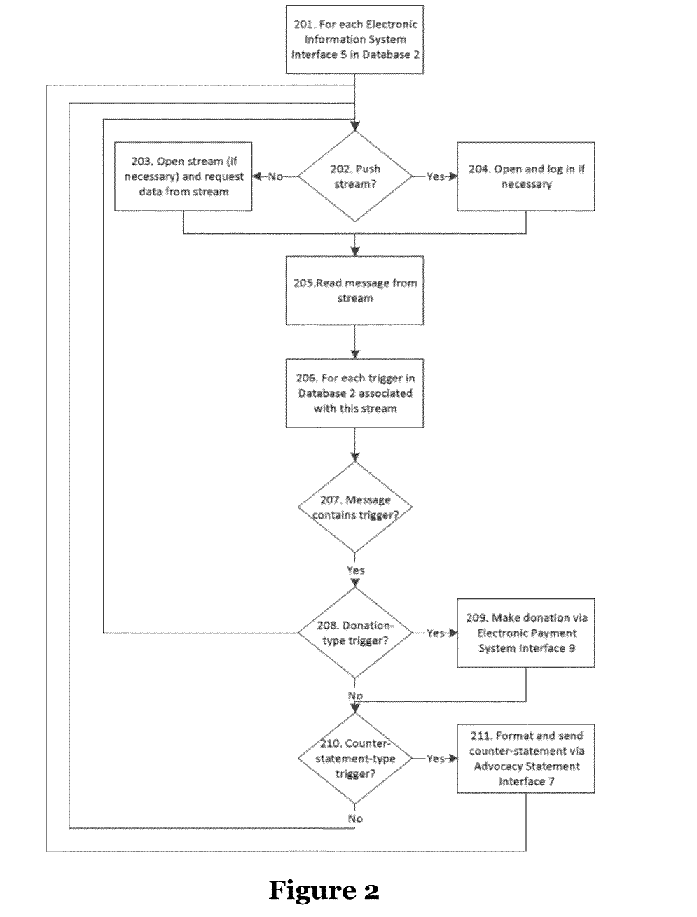

FIG. 1 shows a block diagram of System 1, an embodiment of the present invention. In this embodiment, Control Computer 2 is an off-the-shelf device capable of executing instructions, storing information, and electronically interfacing with other devices using a communications network. Control Computer 2 could be configured with various components known to one of ordinary skill in the art, including multiple CPUs, solid state drive(s), flash memory, optical drives, monitors, keyboards, mice, and so on. In addition, Control Computer 2 includes custom software for implementing the steps of the invention; one embodiment of those steps is shown in FIG. 2 and described below.

The embodiment shown in FIG. 1 also includes Database 3, accessible by Control Computer 2 and containing configuration information required by the invention. An embodiment of Database 3 might include information about (a) registered users (for example, name, password, credit card or banking information, social media login information, and so on), (b) electronic information streams (for example, URL addresses, login information, and so on), (c) trigger condition (for example, the presence of specified keywords, phrases, songs, images, locations, and so on), and (d) advocacy response rules (for example, “when keyword A is found in monitored stream B, make an electronic payment from user C's credit card to organization D), as well as any special configuration parameters for effecting the results of the monitoring (for example, instructions on how to make a payment using PayPal, instructions on how to post to a user's Twitter account, and so on). Database 3 could be implemented in any number of ways known a person of ordinary skill in the art, including by way of example and not limitation, using a relational database and accessed using an SQL interface, as a set of flat files accessed directly by the software, and so on. Table 1 (below) shows one embodiment of how Database 3 could be arranged in a set of records and fields.

TABLE 1

| Record | Fields |
|---|---|
| User/consumer | Name |
| | Password |
| | Email address |
| | Administrator (true/false) |
| Media source | Name |
| | Description |
| | Media streams (Twitter, audio, etc.) |
| Media stream | Name (Twitter, audio web stream, Instagram, etc.) |
| | Trigger list (trigger-1, pledge-1, trigger-2, pledge-2, etc.) |
| Trigger | Media stream |
| | Pledge |
| | Trigger event (instance, keyword, image, duration, etc.) |
| Payment | User |
| | Account (payment system account ID) |
| | Transaction ID (payment system transaction number) |
| | Type (PayPal, etc.) |
| Beneficiary | Name |
| | Description |
| | Funding source (PayPal, etc.) |
| Pledge | User |
| | Media source |
| | Media stream |
| | Trigger |
| | Beneficiary |
| | Payment |

The embodiment shown in FIG. 1 also includes one or more User Device 4. User Device 4 provides an interface through which a consumer of information configures the monitoring and advocacy response parameters of Control Computer 2. User Device 4 can be any device that has a user interface and is capable of electronically communicating with Control Computer 2. By way of example and not limitation, User Device 4 could be a desktop computer, notebook computer, smart phone, tablet, set-top box, gaming system, wearable technology, and so on.

The embodiment shown in FIG. 1 also includes one or more Electronic Information Stream Interface 5 containing electronic information, sent by one or more Media Source 6, from which content may be extracted. By way of example and not limitation, Electronic Information Stream Interface 5 could be a text-only data stream, an audio stream, a video stream, or combinations of each. Electronic Information Stream Interface 5 may use a “push” type interface, where a Media Source 6 automatically sends information through Electronic Information Stream Interface 5 based on a pre-configured subscription, or it could be a “pull” type interface, where Control Computer 2 sends periodic requests to a Media Source 6, and in response, Media Source 6 sends the requested information to Control Computer 2 through Electronic Information Stream Interface 5.

The embodiment shown in FIG. 1 also includes one or more Advocacy Statement Interface 7 which provides the mechanism for sending an advocacy statement to some external Advocacy Platform 8. By way of example and not limitation, Advocacy Platform 8 could be a social media platform such as Facebook, Twitter, or Reddit, it could be an individual or group email account, or it could be virtually any other electronic destination. Control Computer 2 would be programmed with instructions and protocols specific to Advocacy Statement Interface 7 and Advocacy Platform 8, as would be known to a person of ordinary skill in the art.

The embodiment shown in FIG. 1 also includes one or more Electronic Payment System Interface 9 which provides the mechanism for sending a donation from a user to Advocacy Group 10 (or more particularly, for sending instructions for electronically transferring funds from a user's financial institution to Advocacy Group 10's financial institution using Electronic Payment System Interface 9). By way of example and not limitation, Electronic Payment System Interface 9 could link Control Computer 2 to systems for making electronic payments to Advocacy Group 10 via credit cards, electronic fund transfers, PayPal, Western Union, and so on. Control Computer 2 would be programmed with instructions and protocols specific to Electronic Payment System Interface 9—account numbers, routing numbers, standard message formats, and so on—as would be known to a person of ordinary skill in the art.

The embodiment shown in FIG. 1 also includes a Network 11 which may connect Control Computer 2 with one or more User Device 4, one or more Media Source 6, one or more Advocacy Platform 8, and one or more Advocacy Group 10. There are no specific technical requirements for Network 11 other than that it provides connectivity between the various components. By way of example and not limitation, it could have wired and/or wireless segments, it could use standard Internet protocols like HTTP or it could use custom communications protocols, or combinations of both, and there may be multiple logical and/or physical pathways between any of the components.

FIG. 2 shows a flow chart depicting the processing logic of an embodiment of the present invention. For purposes of this example, Database 3 has already been populated with the following initial trigger configuration:
User: Jane Smith
Media stream: Twitter
Media source name: @NRA
Trigger condition: presence of the phrase “second amendment”
Hedge: Donation
Payment: $1.00
Payment type: PayPal
Beneficiary: Brady Campaign to Prevent Gun Violence

(Note that prior to going “live,” Control Computer 2 would likely have performed basic verification on the configuration, for example, to confirm that the system had set up a subscription to follow @NRA, that user Jane Smith had an active PayPal account, and that the system had the necessary information for making a PayPal payment to the Brady Campaign to Prevent Gun Violence.)

In Step 201 of FIG. 2, Control Computer 2 begins cycling through each Electronic Information Stream 5 stored in Database 2. At Steps 202-204, for push-type streams, the system performs any necessary login steps needed to open the stream, and for pull-type streams, Control Computer 2 performs any necessary steps to request updates be sent through the stream. At Steps 206-207, for each new message in the stream, Control Computer 2 compares the contents of the message with each trigger for each user interested in this stream. For the purpose of this example, Control Computer 2 reads the Twitter feed from @NRA and finds a new message “Support the second amendment!” Since this message includes the trigger “second amendment,” Control Computer 2 will recognize a match at Step 207. Next, at Steps 208-211, Control Computer 2 will determine whether the advocacy associated with this trigger is a donation or a counter-statement (or both), and send the appropriate instructions to the electronic payments system and/or social media platform. In this example, the User Jane Smith has configured the trigger to send $1 to the Brady Campaign to Prevent Gun Violence via her PayPal account, and so at Step 209, Control Computer 2 formats and sends appropriate message(s) to PayPal using Electronic Payment System Interface 9.

Note that the steps shown in FIG. 2 are shown in the simplest manner needed to describe an embodiment of the present invention. As would be known to a person having ordinary skill in the art, these steps could be modified and/or rearranged to take advantage of programming efficiencies, to minimize network bandwidth requirements, to account for varying response times from different Electronic Information Stream Interface 5s, to implement parallel or distributed processing, and so on.

Further, in this example, Step 207 used a simple text matching comparison—testing to determine if “second amendment” was found in the string “Support the second amendment.” However, in other embodiments, Step 207 could involve more complex text matching, such as wildcard matching, case independent matching, synonym matching, homophone matching, proximity matching, regular expression pattern matching, and so on.

Further, in embodiments supporting audio in Electronic Information Stream Interface 5, Step 207 could use the presence of a coherent signal—that is, any content that is not noise—as a trigger. Such a trigger might be used when waiting for a one-time broadcast such a speech. The audio content can be parsed to identify triggers based on keywords using speech recognition software. Further, the audio signal itself can be analyzed and matched to known works, such as music performances identified by the application Shazam. For example, a user could select both a known work, for example “It Was a Very Good Year” performed by Frank Sinatra as a first trigger and the key word “girl” as a second trigger. Both the first and second triggers would be satisfied by the same song appearing within the stream.

Further, in embodiments supporting still images in Electronic Information Stream Interface 5, Step 207 could use the presence of an image within an Instagram or Flickr stream as a trigger. Images can be parsed for triggers based on keywords through the use of optical character recognition processing. Optical character recognition analyzes image data to identify numbers and letters present within the image and these individual characters can be combined into words that can be compared to the trigger keywords. Images can also be parsed for other content recognition, such as shapes, faces, symbols, or other visual elements submitted or selected by the user as a trigger.

Further, in embodiments supporting video in Electronic Information Stream Interface 5, Step 207 could use the presence of video content within the stream as a trigger, such as the beginning of a streaming broadcast of an event. Video media streams can also be parsed based on the length of the video such as if a speech lasts longer than a single threshold limit, for example, over 8 minutes, or for a reoccurring threshold, for example, every 1 minute of length is an additional trigger. Video media streams can also be parsed for keyword triggers by analyzing any accompanying audio as detailed above or by comparing keywords to a transcript of the video. Individual frames of a video stream can also be analyzed like still images as described in the previous paragraph.

Further, some Electronic Information Stream Interface 5s may include geographic location information. For example, photographs may include latitude and longitude information about where the photograph was taken, and social media platforms may allow the user to add “location” or “checking in” information to a posting. In some embodiments, Step 207 could compare the geographic location information in a stream—for example a geographic longitude/latitude or a named location—with a location at or near a user-specified location. “Near” in this example could be a default proximity value defined by the system or a user-defined proximity value. A match could, for example, invoke an advocacy counter-statement or donation whenever there was a message indicating that the poster had “checked in” to a political event held at an identifiable location.

Further, in some embodiments, Step 207 could involve threshold comparisons, for example comparing the number of Twitter “followers” or Facebook “likes” or “shares” to a threshold set by the user, and Steps 208-209 could make the size of the donation be a multiple of the user's threshold, for example, $1 for every 10 followers. Further, in some embodiments, rather than examining the stream for specific content, Step 207 could involve counting the number of tweets, postings, messages, comments, and so forth, and invoking Steps 209 and/or 211 when that count exceeded the user's threshold.

Further, in some embodiments, Step 207 could include multiple related or unrelated comparisons combined using Boolean operators. By way of example, a compound test might be testing for the presence of “gun control” AND (“senator smith” OR “senator brown”) AND NOT “H.R. 1234.”

Further, in some embodiments, Steps 208-211 could further involve recording the number of donations, the recipients of tweets, and other statistics associated with advocacy response taken on behalf of users and/or for the benefit of advocacy groups. In some embodiments, the system could place periodic caps on the number of advocacy messages sent and/or the aggregate amount of money donated. By way of example and not limitation, a user may choose to limit weekly donations to a specific beneficiary to $30/month.

Further, in some embodiments where the advocacy response was a donation, Step 209 may aggregate payments such that they are made on a periodic basis—once a day, once a week, and so on. Alternatively, Step 209 may aggregate payments such that they are made only after reaching a certain amount. These embodiments would avoid, for example, making a dozen $0.50 electronic payment system transactions over the course of a day, and instead making a single $6.00 electronic payment system transaction at the end of the day.

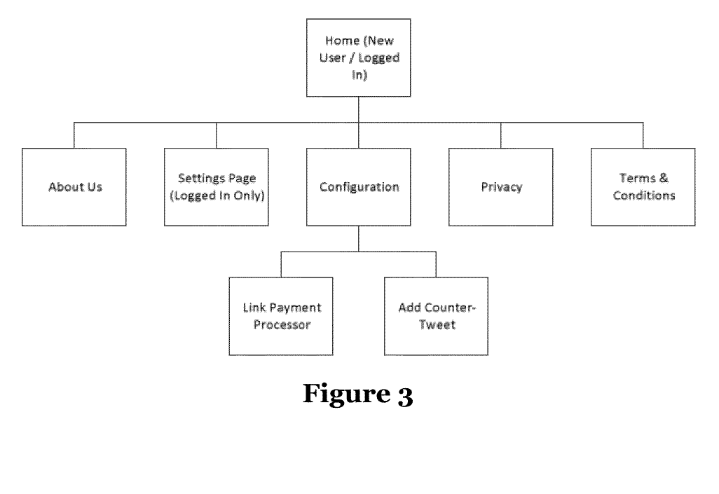

FIG. 3 through FIG. 9 show examples of configuration screens that could be used with various embodiments of the present invention. FIG. 3 shows how the various web based user interface pages that is established to implement the system of the present invention might be organized. Key components of that organization include a home page for users to create an account or to log in to an existing account, a settings page on which a user establishes all of the parameters of his or her pledges, donations and, if chosen, counter-active postings or other measures, and a page allowing the user to link his or her donations to a payment processor that will fulfill the pledges that have been made.

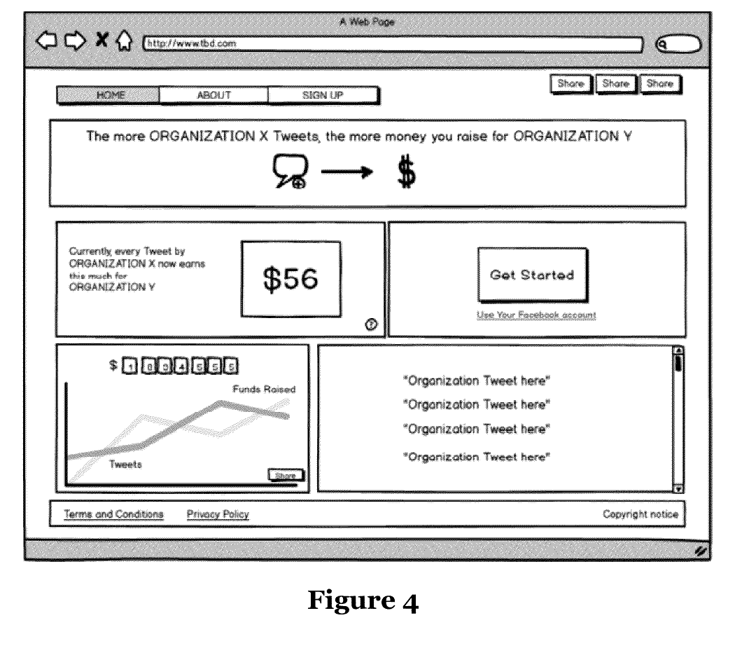

FIG. 4 shows a detailed example of a sample home page that could be presented to an end user to reflect the operations of the system and methodology of this invention. As noted, one aspect of this system and methodology is the aggregation of pledges and donations for multiple users and feedback to each individual user with respect to the total amount of funds that are pledged and donated to a particular advocacy group. In this sample, the triggering entity is referred to as “ORGANIZATION X” and the beneficiary designated to receive funds is referred to as “ORGANIZATION Y”. The example that is depicted in FIG. 4 shows that at the particular point in time reflected on that page, when ORGANIZATION X releases a tweet, users who presumably oppose the philosophies espoused by ORGANIZATION X collectively donate $56 to ORGANIZATION Y, which is presumably an organization with a philosophy that is contrary to ORGANIZATION X's philosophy. The field in the lower left-hand corner of this sample home page records the total amount of funds raised ($1,834,555) through the system and methodology of this invention and specifically as a counter-active measure to tweets released by ORGANIZATION X. This amount will not necessarily be an even multiple of the amount shown at the lower left corner because users will variously register to donate, terminate their registrations, or reach their donation limits. Thus, the donation per tweet will continuously change and the total amount donated will continuously change. The system and methods of this embodiment may include internal tracking algorithms to record all of this.

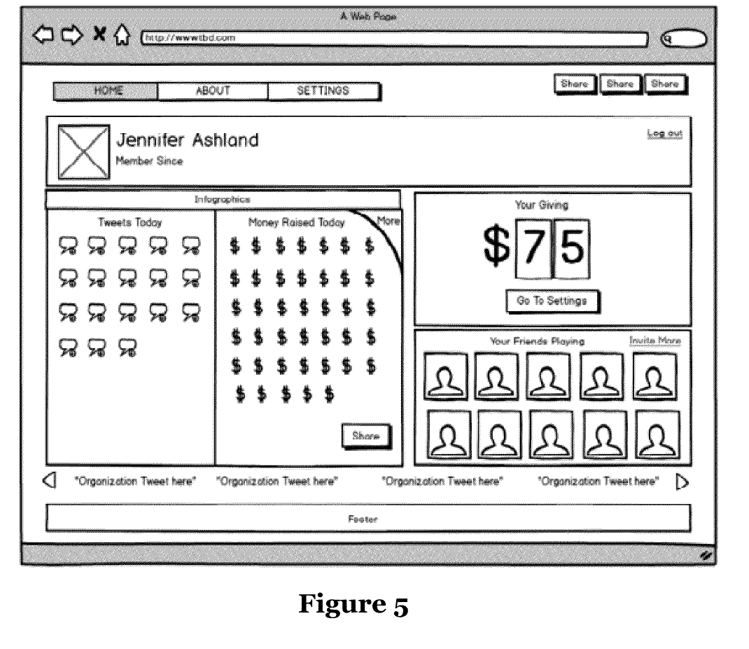

FIG. 5 shows an alternate sample user page that shows only the amounts pledged and donated by one user. The administrator or developer of this embodiment is therefore free and able to configure the user pages as is most appropriate to any given situation. The total amount donated to an organization can be kept confidential, for example, and individual users need not be informed of the total amount of donations that are given to any particular organization.

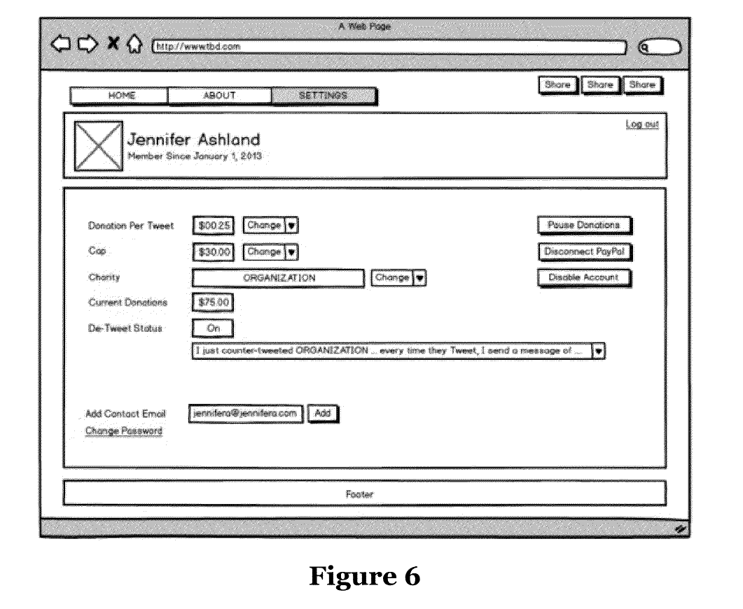

FIG. 6 shows a sample web page depicting how a user may establish settings for his or her donations via a series of prompts for donation and organization information into the system and methodology of the present invention. In this embodiment, the user can cap the total amount that he or she wants to donate, “pause” the pledge and, as a safeguard, disconnect his account within this system from the payment system that has been connected in order to relay the donated funds to the designated organization. These and other safeguard features will give the end user a sense of comfort and a feeling of control over the methodology of this invention, notwithstanding its automatic nature.

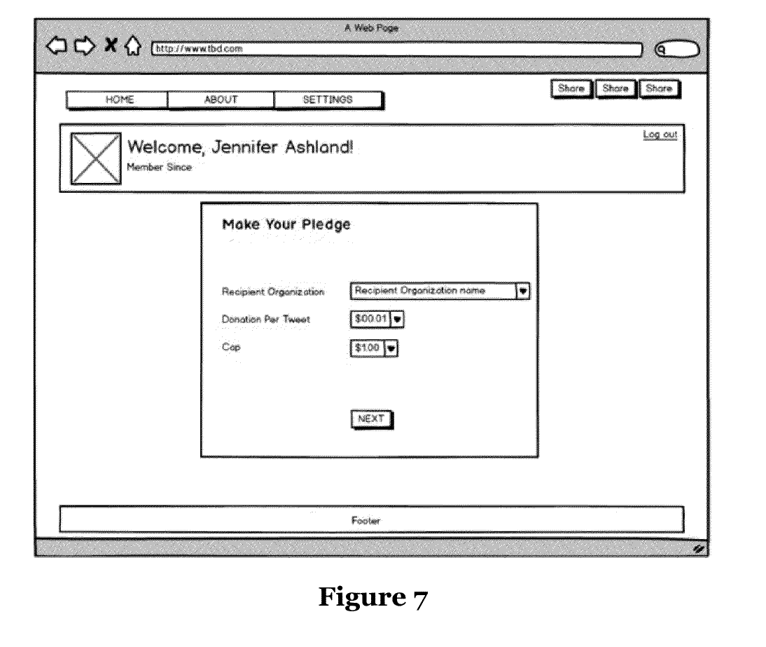

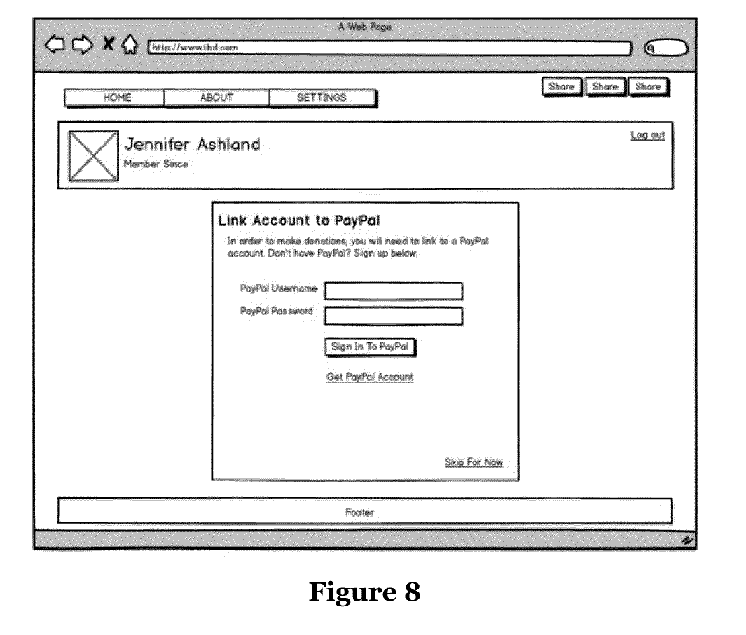

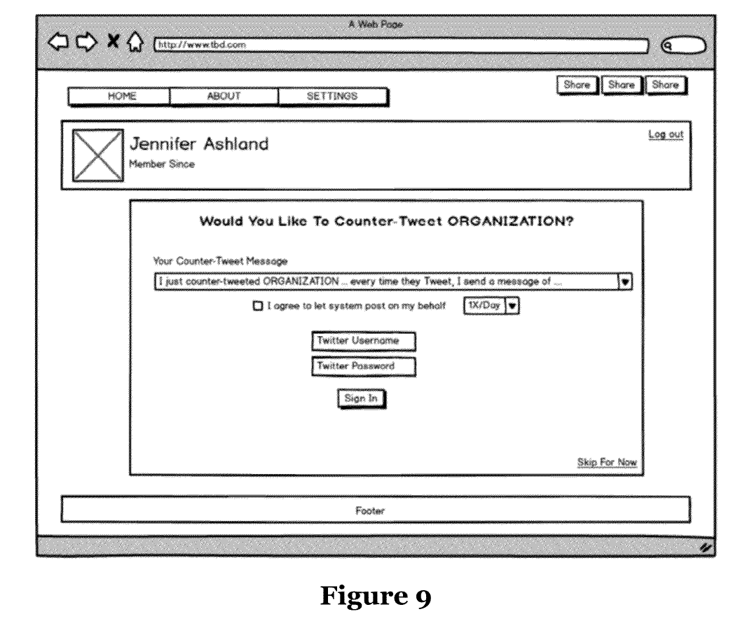

FIG. 7, FIG. 8, and FIG. 9 show alternative sample web pages that may be implemented to further break down a user's inputs in embodiments of the present invention. Whether these inputs are each isolated to single web pages, as shown in these figures, or whether they are all implemented through a single web page is within the discretion of the programmer who is writing the specific programming that implements these embodiments.

FIG. 3 through FIG. 9 are only examples of the configuration of the present invention. A simplified embodiment may be used for monitoring a single or small number of Electronic Information Stream Interface 5s for the benefit of a single Advocacy Group 10. By way of example and not limitation, such an embodiment could be preconfigured to monitor the National Rifle Association's presence on Facebook, Twitter, Google+, Instagram, YouTube, and Pinterest. The monitored could be limited to instances of a preselected set of phrases. The advocacy response rules could be limited to donations to a few preselected Advocacy Group 10s. In this embodiment, while the user interface would be much simpler—perhaps a single page with some fill-in-the-blanks and check-boxes—the underlying processing would be similar or even identical to the embodiment shown in FIG. 2.

Additionally, a second simplified embodiment could involve a customized Step 207 which understands how to parse and interpret an electronic information stream for more information than just an instance of a keyword. This could, by way of example and not limitation, include receipt and interpretation of a live sport play-by-play feed or periodically scraping a sports website for box scores, player statistics, specific game events, and so forth. Upon recognition of the occurrence of a preconfigured event, say a missed field goal, the system would automatically make an electronic donation on behalf of the user to the United Way. (This embodiment assumes that the system can accurately parse and interpret the content of the electronic information stream, and it may also require some pre-screening of the donation recipients in order to comply with governmental gaming industry regulations.)

Additionally, a third simplified embodiment could involve monitoring a one-time scheduled electronic information stream rather than a repeated stream. By way of example and not limitation, the operator of a system practicing an embodiment of the present invention could configure an audio or text feed from the president's annual state of the union address, and for a limited time prior to the speech, allow users to set up donations based on the presence of words in the speech. So for example, every time the president used the word “economy” in the speech, the system would automatically make a donation to a charity of the user's choice.

While specific embodiments have been illustrated and described, numerous modifications come to mind without significantly departing from the spirit of the invention and the scope of protection is only limited by the scope of the accompanying Claims.

1. A system comprising:
a computer network interface;
a computer database comprising (a) data about a specified user of the system, the user data comprising a name and password, (b) data about a specified electronic information stream, the stream data being sufficient to enable the use of the computer network interface to receive messages from the electronic information stream, and (c) an advocacy response rule, the advocacy response rule comprising a trigger condition and an advocacy response;
a computer software module comprising programming to:
receive a message associated with the electronic information stream via the network interface,
examine the message according the trigger condition, and
if the trigger condition is met by the message, invoke the advocacy response.

2. The system of claim 1, wherein:
the message comprises a first text string;
the trigger condition is the presence of a second text string; and
the computer software module further comprises programming to invoke the advocacy response when the first text string contains the second text string.

3. The system of claim 1, wherein:
the message comprises a first image;
the trigger condition is the presence of a second image; and
the computer software module further comprises programming to invoke the advocacy response when the first image contains the second image.

4. The system of claim 1, wherein:
the message comprises a first geographic location;
the trigger condition is a proximity to a second geographic location; and
the computer software module further comprises programming to invoke the advocacy response when the first geographic location is within the proximity of the second geographic location.

5. The system of claim 1, wherein:
the advocacy rule further comprises a numeric threshold value; and
the computer software module further comprises programming to:
increment a counter whenever the message includes the trigger condition and
invoke the advocacy response when the counter equals the numeric threshold value.

6. The system of claim 1, wherein:
the user information in the database further comprises information sufficient to use the computer network interface to make an electronic financial transfer using funds belonging to the user; and
the database further comprises (d) data about a funds recipient, the recipient data being sufficient to enable the use of the computer network interface to make an electronic financial transfer for the benefit of the recipient; and
the advocacy response comprises using the computer network interface to make an electronic transfer of funds belonging to the user for the benefit of the recipient.

7. The system of claim 1, wherein:
the database further comprises (e) an advocacy message;
the database further comprises (f) data about a social media platform, the social media platform data being sufficient to enable the use of the computer network interface to submit a request to post the advocacy message on the social media platform; and
the advocacy response comprises using the computer network interface to submit a request to post the advocacy message on the social media platform.

8. A method of using a computer to automatically submit an advocacy message comprising:
receiving, via a network interface of the computer, a message from an electronic information stream associated with a first social media platform, the message comprising a first text string;
comparing, using a program executing on the computer, the first text string to a second text string; and
if the first text string contains the second text string, automatically submitting, via the network interface of the computer, an advocacy message to a second social media platform.

9. The method claim 8, wherein:
the first social media platform and the second social media platform are the same.

10. A method of using a computer to automatically invoke an electronic transfer of funds comprising:
receiving, via a network interface of the computer, a message from an electronic information stream associated with a social media platform, the message comprising a first text string;
comparing, using a program executing on the computer, the first text string to a second text string; and
if the first text string contains the second text string, automatically submitting, via the network interface of the computer, instructions for electronically transferring a sum of money from a first financial account to a second financial account.
